(19) United States
(12) Patent Application Publication
(10) Pub. No.: US 2026/0275034 A1
(43) Pub. Date: Sep. 17, 2026

(54) PROCESS FOR PRODUCING POLYCARBONATE

(71) Applicant: SABIC GLOBAL TECHNOLOGIES B.V., Geleen (NL)

(72) Inventors: Prashant Kumar, Evansville, IN (US); William Earl Hollar, JR., Mount Vernon, IN (US); Lourdes Virginia Serna Felix, Evansville, IN (US); Fernan Mateos Salvador, Cartagena (ES); Mark Erik Nelson, Mt. Vernon, IN (US); Hoang Nguyen, Houston, TX (US)

(21) Appl. No.: 19/589,419

(22) PCT Filed: Nov. 21, 2024
(86) PCT No.: PCT/EP2024/083061

§ 371 Date: May 21, 2026

(30) Foreign Application Priority Data
Nov. 22, 2023 (EP) 23383193.2
Nov. 22, 2023 (EP) 23383194.0

(51) Int. Cl. C08G 64/40; C08J 3/00

(52) U.S. Cl. CPC C08G 64/406; C08J 3/00

(57) ABSTRACT

The invention relates to a process for producing polycarbonate comprising the steps of
a) providing a solution of polycarbonate in an organic solvent wherein the solution comprises 5-40 wt. % of polycarbonate, based on the weight of the solution,
b) concentrating and heating the solution of step a) to form a concentrated polycarbonate melt comprising the solvent wherein the concentrated polycarbonate melt comprises at most 5 wt. % and more than 500 ppm of solvent, based on the weight of the concentrated polycarbonate melt and
c) further concentrating the concentrated polycarbonate of step b) to a polycarbonate comprising at most 500 ppm of organic solvent,
wherein
step b) is carried out by subjecting the solution to at least two devolatalization stages in series, wherein each devolatalization stage comprises heating the solution by means of a heat exchanger and subsequently feeding the heated solution to a degassing vessel, wherein at least part of the solvent is separated from the solution by evaporation, and step c) is carried out at least in a degassing extruder.

### CROSS REFERENCE TO RELATED APPLICATIONS

This application is a National Stage application of PCT/EP2024/083061, filed Nov. 21, 2024, which claims the benefit of European Application No. 23383193.2, filed Nov. 22, 2023, and claims the benefit of European Application No. 23383194.0, filed Nov. 22, 2023, all of which are incorporated by reference in their entirety herein.

### BACKGROUND

The present invention relates to a process for producing polycarbonate.

Polycarbonates are a widely used class of thermoplastic materials, which are prized for their superior clarity and physical toughness. One preferred method of producing polycarbonates, which is commonly referred to as the “interfacial method,” comprises reacting phosgene and bisphenol-A in a two-phase system having an aqueous and a nonaqueous phase of a solution of polycarbonate in an organic solvent. Next, the aqueous phase is typically removed and the nonaqueous phase is purified to remove residual salts, catalysts and other impurities. After purification, the organic solvent is removed and polycarbonate is isolated from the nonaqueous phase.

Various processes are known for the isolation. The residual contents of the organic solvent in the end product should be as low as possible since they are disruptive in the polycarbonate. The isolation may result in polycarbonate powder, which can be mixed with any further components and extruded into pellets. The isolation may also directly result in pellets.

U.S. Pat. No. 10,435,507 discloses a process for obtaining an aromatic polycarbonate comprising low content of residual organic solvent. A polymer solution containing 65% by weight of polycarbonate, 33.5% by weight of chlorobenzene and 1.5% by weight of dichloromethane was heated in a downpipe devolatilizer to exit to a separation vessel. The residual content of chlorobenzene was 5000 ppm and the residual content of dichloromethane was 50 ppm. The concentrated polymer solution was supplied to a static mixer to which 0.1% by weight of nitrogen was added. The polymer melt containing the nitrogen was devolatilized further in a foam devolatilizer consisting of separation vessels which was directly above a devolatilizing extruder. The residual chlorobenzene content downstream of the foam devolatilizer was 20 ppm. The devolatilizing extruder was equipped with three devolatilizing zones. The residual chlorobenzene content was 2 ppm. Dichloromethane was no longer detectable (<0.1 ppm).

U.S. Pat. Nos. 6,534,619 and 6,620,906 disclose a multi-step continuous process for evaporating polymer solutions by indirect heat exchange by concentrating a solution containing 5 to 20 wt. % of polymer to a solution containing 60 to 75 wt. % of polymer using a shell-and-tube heat exchanger, a film evaporator and a coiled-tube evaporator is used in combination with a downstream separator, further concentrating the solution to produce a solution that contains at least 95 wt. %, polymer in a shell-and-tube heat exchanger and a downstream separator, further concentrating the solution to bring the content of solvent and/or other volatile constituents to 5 to 500 ppm in a shell-and-tube heat exchanger with downstream separator or in an extrusion evaporator with separator.

It is an object of the invention to provide a process for producing polycarbonate with low residual contents of organic solvent.

### SUMMARY

Accordingly, the invention provides a process for producing polycarbonate comprising the steps of
a) providing a solution of polycarbonate in an organic solvent wherein the solution comprises 5-40 wt. % of polycarbonate, based on the weight of the solution,
b) concentrating and heating the solution of step a) to form a concentrated polycarbonate melt comprising the organic solvent wherein the concentrated polycarbonate melt comprises at most 5 wt. % and more than 500 ppm of organic solvent, based on the weight of the concentrated polycarbonate melt and
c) further concentrating the concentrated polycarbonate melt of step b) to a polycarbonate comprising at most 500 ppm of organic solvent,
wherein
step b) is carried out by subjecting the solution to at least two devolatalization stages in series, wherein each devolatalization stage comprises heating the solution by means of a heat exchanger and subsequently feeding the heated solution to a degassing vessel, wherein at least part of the solvent is separated from the solution by evaporation, and step c) is carried out at least in a degassing extruder.

### BRIEF DESCRIPTION OF THE DRAWINGS

The above and other advantages and features of this disclosure will become more apparent by describing in further detail exemplary embodiments thereof with reference to the accompanying drawings, in which:

FIG. 1 illustrates an example of a system for carrying out the disclosed process for producing polycarbonate.

### DETAILED DESCRIPTION

The process according to the invention results in a concentrated polycarbonate with a low amount of organic solvent in an efficient manner. The concentration range of polycarbonate in the solution of step a) gives a relatively low viscosity to the solution which makes it easier to process in the following concentration step. The concentration step by devolatalization stages in step b) by which the concentrated polycarbonate melt obtained has more than 500 ppm and at most 5 wt. % of solvent is advantageous in that the reduction of the solvent to a desired level can be efficiently achieved in subsequent steps. Reduction of solvent to 500 ppm or less of solvent by such devolatalization stages requires an undesirably large amount of energy.

### Step a)

Step a) involves providing a solution of polycarbonate in an organic solvent wherein the solution comprises 5-40 wt. % of polycarbonate based on the weight of the solution. The solution may comprise 60-95 wt. % of the organic solvent based on the weight of the solution. This concentration range of polycarbonate in the solution gives a relatively low viscosity to the solution which makes it easier to process in the following concentration step.

Such solution can be obtained by interfacial polycarbonate process which is per se well-known. In some preferred embodiments, the solution to be used in the subsequent step b) is a solution directly from a polymerization reactor of an interfacial polycarbonate process.

Preferably, the polycarbonate solution comprises 15-30 wt. % of polycarbonate based on the weight of the solution. The solution may comprise 70-85 wt. % of the organic solvent.

Preferably, the organic solvent comprises from 70 wt. % to 90 wt. % of methylene chloride.

Preferably, the organic solvent is methylene chloride, chlorobenzene or a mixture of chlorobenzene and methylene chloride, preferably the organic solvent is methylene chloride.

### Step b)

Step b) involves concentrating and heating the solution of step a) to form a concentrated polycarbonate melt comprising the organic solvent. The concentrated polycarbonate melt comprises at most 5 wt. % and more than 500 ppm of solvent, based on the weight of the concentrated polycarbonate melt.

Step b) is carried out by subjecting the solution of step a) to at least two devolatalization stages in series. Each devolatalization stage comprises heating the solution by means of a heat exchanger and subsequently feeding the heated solution to a degassing vessel. In the degassing vessel, at least part of the solvent is separated from the solution by evaporation. The number of the devolatalization stages in series in step b) may e.g. be 2, 3, 4, 5 or 6, preferably 2 or 3.

The solution may be supplied to the heat exchanger at a top part to flow downwardly or at a bottom part to flow upwardly.

Preferably, the solution is supplied to the heat exchanger at a bottom part of the heat exchanger. This has an additional degree of freedom represented by the orifice or control valve for regulating the pressure between the outlet of the heat exchanger and the inlet of the degassing vessel.

Thus, in some preferred embodiments, at least one of the heat exchangers is supplied with the solution at a bottom part of the heat exchanger and the solution is heated in the heat exchanger by flowing upwardly from the bottom part to a top part of the heat exchanger. In particular embodiments, each of the heat exchangers is supplied with the solution at a bottom part of the heat exchanger and the solution is heated in the heat exchanger by flowing upwardly from the bottom part to a top part of the heat exchanger.

In other embodiments, at least one of the heat exchangers is supplied with the solution at a top part of the heat exchanger and the solution is heated in the heat exchanger by flowing downwardly from the top part to a bottom part of the heat exchanger. More preferably, each of the heat exchangers is supplied with the solution at a top part of the heat exchanger and the solution is heated in the heat exchanger by flowing downwardly from the top part to a bottom part of the heat exchanger.

The concentration step by such devolatalization stages by which the concentrated polycarbonate melt obtained has more than 500 ppm and at most 5 wt. % of solvent is advantageous in that the subsequent mechanical finisher(s) can efficiently reduce the solvent amount to a desired level. Reduction of solvent to 500 ppm or less of solvent by such devolatalization stages requires an undesirably large amount of energy.

The concentration step of the solution of step a) to achieve the desired solvent concentration is performed by selecting the pressure and temperature of each of the devolatalization stages. It was found according to the invention that the devolatalization should be performed at a relatively high pressure when the organic solvent comprises methylene chloride in a relatively high amount. A too low pressure such as typically employed for removal of chlorobenzene may remove too much solvent which increases the viscosity to such a high level that it becomes difficult for the solution to flow through piping and system.

### Step c)

The process according to the invention further comprises the step c) of further concentrating the concentrated polycarbonate melt of step b) to a polycarbonate comprising at most 500 ppm of organic solvent. Step c) is carried out at least in a degassing extruder. A degassing extruder comprises one or more degassing zones. In some embodiments, the amount of organic solvent in the polycarbonate obtained from step c) is at most 100 ppm, preferably at most 60 ppm, more preferably at most 50 ppm, more preferably at most 10 ppm. In some embodiments, the amount of organic solvent in the polycarbonate obtained from step c) is from 5 ppm to 50 ppm.

In some embodiments, the concentrated polycarbonate melt of step b) is transferred from the last degassing vessel to the degassing extruder.

In other embodiments, the concentrated polycarbonate melt of step b) is transferred from the last degassing vessel to one or more mechanical finishers before being fed to the degassing extruder. Thus, in some embodiments, in step c) prior to feeding the concentrated polycarbonate to said degassing extruder the concentrated polycarbonate is further concentrated in one or more mechanical finishers, wherein inside the mechanical finisher(s) the concentrated polycarbonate melt is maintained in molten state under vacuum conditions at a pressure of at most 50 kPa (500 mbar) and wherein said mechanical finishers continuously or intermittently allows for the renewal of the surface area of the polycarbonate melt that is exposed to the vacuum.

A mechanical finisher has relatively long residence times and thus exerts relatively low shear stress on the material being processed, avoiding a large increase in local processing temperatures. Accordingly, a mechanical finisher generates less heat to the material being processed and thus causes less product degradation, compared e.g. to a degassing extruder. Accordingly, the use of a mechanical finisher for this concentration step in this embodiment advantageously provides polycarbonate with low residual contents of organic solvent and low contents of degradation products.

The concentrated polycarbonate melt obtained by the one or more mechanical finishers comprises at most 500 ppm of organic solvent. In some embodiments, the amount of organic solvent in the polycarbonate obtained by the one or more mechanical finishers is at most 100 ppm, preferably at most 60 ppm, more preferably at most 50 ppm, more preferably at most 10 ppm. In some embodiments, the amount of organic solvent in the polycarbonate obtained by the one or more mechanical finishers is from 5 ppm to 50 ppm.

Methylene chloride is more difficult to remove from a polycarbonate melt than e.g. chlorobenzene, in particular it is difficult to remove methylene chloride from a polycarbonate melt such that its concentration is very low such as at most 500 ppm.

Accordingly the present invention is particularly advantageous when a large proportion of the organic solvent is methylene chloride.

Inside the mechanical finisher(s) the concentrated polycarbonate melt is maintained in molten state under vacuum conditions at a pressure of at most 500 mbar. Preferably, the temperature inside the mechanical finisher is from 250° C. to 350° C. Preferably, the pressure is from 1 to 500 mbar, for example 50 to 500 mbar.

Unlike a degassing extruder, the internal volume of the mechanical finisher occupied by the polycarbonate melt is relatively low. Preferably, the volume occupied by the polycarbonate melt in the mechanical finisher is at most 60%, preferably at most 50%, of the internal volume of the mechanical finisher. The volume occupied by the polycarbonate melt in the mechanical finisher can be calculated using the known internal volume of the mechanical finisher and the material feed rate.

The residence time in a mechanical finisher is typically longer than the residence time in a degassing extruder. Preferably, the residence time in the mechanical finisher is at least 5 minutes, for example 10 minutes to 2 hours.

Preferably, the mechanical finisher is selected from at least one of a disc-ring reactor, a disc-cage reactor, a thin film evaporator or wiped film evaporator, a falling film evaporator, a horizontal twin-shaft polymerizer, twin-screw kneader and wire-wetting fall polymerizer. These devices are per se well-known.

Disc-ring reactor is described e.g. in U.S. Pat. No. 7,550,116, incorporated herein by reference. Disc-ring reactors are typically cylindrical, horizontal, heated vessels with inlet and outlet connections for the precondensate and polycondensate on opposite ends of the disc-ring reactor. The disc-ring reactor comprises a plurality of elements rotating about a horizontal axis, which elements mix the precondensate and produce a large surface for outgassing the polycondensate when the viscous liquefied material adhering to these elements runs down. The design of the discs can be optimized along the shaft of the reactor, so they are adapted to the evolving viscosity at each point. Disc ring reactor is described also in US2005222371, incorporated herein by reference. In some preferred embodiments, the mechanical finisher is a disc-ring reactor and the residence time in the disc-ring reactor is 10 minutes to 3 hours, for example 60 minutes to 3 hours.

Disc-cage reactor is described e.g. in US20020188091, WO2004101140A1 and WO2007128159A1, incorporated herein by reference. Disc-cage reactor comprises a rotatable cylindrical basket having a cylindrical perforated wall and annular discs positioned at intervals around the periphery of said basket and along the length thereof. The design of the discs can be optimized along the shaft of the reactor, so they are adapted to the evolving viscosity at each point. In some preferred embodiments, the mechanical finisher is a disc-cage reactor and the residence time in the disc-ring reactor is 10 minutes to 3 hours, for example 60 minutes to 3 hours.

Thin film evaporator and wiped film evaporator are described e.g. in U.S. Pat. No. 10,384,145, incorporated herein by reference. Typically a thin film evaporator comprises a vertical or horizontal drum, a supply line which is used to supply the product that is to be evaporated, a heating jacket arranged on the periphery of the drum, a discharge line for discharging the residue left and a discharge line for discharging the evaporated portion of the product. The overall purpose of the thin film evaporator is to evaporate volatile fluids from less volatile fluids. The evaporation occurs by the contact between the product and the heated walls of the drum. To improve the evaporation efficiency, the drum is provided with an agitation means. The agitation may be made in a number of ways. One well known type is an agitator of the fixed clearance type in which a thin gap is formed between the agitator and the inner wall of the drum, whereby the agitator during rotation forces the product towards the thin gap. Another type is a so called wiped film agitator, in which the agitator wipes the product against the inner wall of the drum, thereby forming a thin product film. In some preferred embodiments, the mechanical finisher is a thin film evaporator or wiped film evaporator and the residence time in the thin film evaporator or wiped film evaporator is at least 5 minutes and below 10 minutes.

Falling film evaporator is described e.g. in U.S. Pat. No. 9,040,639 and WO2003042278A1, incorporated herein by reference. The process fluid to be evaporated flows downwards by gravity as a continuous film. The fluid will create a film along the tube walls, progressing downwards (falling). In some preferred embodiments, the mechanical finisher is a falling film evaporator and the residence time in the falling film evaporator is at least 5 minutes and below 10 minutes.

Horizontal twin-shaft polymerizer is described e.g. in EP0529093B1 and U.S. Pat. No. 6,846,103, incorporated herein by reference. Horizontal twin-shaft polymerizer is a polymerizer having two horizontal shafts of rotation equipped with blades which can be of disk-type, pin-type, spectacles-type or wheel-type. The horizontal twin-shaft polymerizer is preferably provided with a distillation column. The distillation column is useful for avoiding the escape of the starting compounds from the system upon removal of by-products. In some preferred embodiments, the mechanical finisher is a horizontal twin-shaft polymerizer and the residence time in the horizontal twin-shaft polymerizer is 10 to 60 minutes.

Twin-screw kneader is described e.g. in US20090304800A1, incorporated herein by reference. Examples of twin-screw kneaders include KRC Kneader available from Kurimoto, Ltd. In some preferred embodiments, the mechanical finisher is a twin-screw kneader and the residence time in the horizontal twin-screw kneader is 10 to 30 minutes.

Wire-wetting fall polymerizer is described e.g. in U.S. Pat. No. 5,589,564A, CA2168630C, U.S. Pat. Nos. 6,277,945B1, 6,320,015B1, 7,528,213B2 and 9,321,884B2, incorporated herein by reference. In a wire-wetting fall polymerizer, a molten prepolymer is allowed to fall along and in contact with the surface of a guide, such as a wire, thereby effecting polymerization of the molten prepolymer to produce a desired polymer. In some preferred embodiments, the mechanical finisher is a wire-wetting fall polymerizer and the residence time in the wire-wetting fall polymerizer is 10 to 60 minutes.

Preferably, an inert gas other than the solvent is added to the mechanical finisher. Examples of the inert gas include nitrogen, argon, carbon dioxide, water, methane helium and combinations thereof.

The concentrated polycarbonate melt of step b) from the last degassing vessel or the one or more mechanical finishers is fed to a degassing extruder. Pellets may be obtained.

As is known to the skilled person, an extruder is a device comprising an elongated cylindrical tube (barrel) having an inlet and an outlet and screw(s) configured to rotate in the barrel to convey material from the inlet to the outlet of the barrel.

Also as is known to the skilled person, a degassing extruder is an extruder having one or more degassing zones in the barrel, in which degassing zones low molecular weight species are extracted via vacuum.

Preferably, an inert gas other than the solvent is added to the degassing extruder. Examples of the inert gas include nitrogen, argon, carbon dioxide, water, methane helium and combinations thereof.

In step c), the polycarbonate comprising at most 500 ppm of organic solvent is obtained in the barrel of the degassing extruder. Subsequently, the polycarbonate comprising at most 500 ppm of organic solvent is extruded to obtain one or more strands, which are subsequently cooled and cut into pellets.

Accordingly, the process according to the invention preferably comprises d) extruding the polycarbonate obtained by step c) from the degassing extruder into one or more strands, which are subsequently cooled and cut into pellets.

A die head is arranged after the outlet of the barrel and one or more strands come out of the die head, which strands are subsequently cooled and solidified and cut into pellets. There may be components such as a gear pump and/or a melt filter between the outlet of the barrel and the die head, but no degassing step takes place between the outlet of the barrel and the die head. For example, the outlet of the barrel may be directly followed by a die-head, the outlet of the barrel may be followed by a gear pump and then a die-head, the outlet of the barrel may be followed by a gear pump, then a melt filter and then a die-head, the outlet of the barrel may be followed by a melt filter, then a gear pump and then a die-head, or the outlet of the barrel may be followed by a gear pump, then a melt filter, then a further gear pump and then a die-head.

Preferably, the volume occupied by the polycarbonate melt in the degassing extruder is more than 60%, preferably at least 70% or at least 80% of the internal volume of the extruder.

Preferably, the residence time in the degassing extruder is less than 5 minutes, for example 10 seconds to 3 minutes or 30 seconds to 2 minutes.

Preferably, in the degassing extruder, the amount of organic solvent in the polycarbonate is reduced to at most 10 ppm.

The degassing extruder is operated such that desired organic solvent content will be obtained. For example, temperature, pressure, screw speed (RPM) and output rate (kg/h) can be adjusted. The degassing extruder can be operated e.g. at 280 to 350° C. For preventing the polycarbonate from yellowing, the temperature in the degassing extruder is preferably set to 280 to 320° C.

Degassing extruder or devolatilizing extruder is per se known and described e.g. in U.S. Pat. No. 10,435,507 and “Der gleichläufige Doppelschneckenextruder” [The Corotatory Twin-Screw Extruder], Klemens Kohlgrüber, Carl Hanser Verlag, ISBN 978-3-446-41252-1, on pages 193-195, referred in U.S. Pat. No. 10,435,507.

In the extruder, the concentrated polycarbonate melt may be combined with additives or other components. The obtained composition from the extruder may be cut into pellets.

Suitable examples of the optional additives include one or more of an impact modifier, flow modifier, filler, reinforcing agent (e.g., glass fibers or talc), antioxidant, heat stabilizer, light stabilizer, UV light stabilizer and/or UV absorbing additive, plasticizer, lubricant, release agent, in particular glycerol monostearate, pentaerythritol tetra stearate, glycerol tristearate, stearyl stearate, antistatic agent, antifog agent, antimicrobial agent, colorant (e.g., a dye or pigment), flame retardant either or not combined with an anti-drip agent such as polytetrafluoroethylene (PTFE) or PTFE-encapsulated styrene-acrylonitrile copolymer. The present invention is not limited in terms of the type and amount of additives and an embodiment is possible wherein none of these additives exemplified above is added.

Other components that may be added to the extruder may e.g. be at least one further polymer, preferably selected from the group consisting of polycarbonate-polyorganosiloxane copolymers, polycarbonate-polyester copolymers, polyesters, polyolefins, acrylonitrile/butadiene/styrene copolymer, methyl methacrylate/butadiene/styrene copolymer, styrene/butadiene/styrene copolymer (SBS), styrene/ethylene-butylene/styrene copolymer (SEBS), styrene/ethylene-propylene/styrene copolymer (SEPS) styrene/acrylonitrile copolymer (SAN), acrylonitrile/styrene/acrylonitrile copolymer (ASA), polybutylene terephthalate (PBT), polyethylene terephthalate (PET), unsaturated polyester (UPES), polyamide (PA), thermoplastic urethane (TPU), polystyrene (PS), high impact polystyrene (HIPS), polyvinyl chloride (PVC), polyetherimides, polysulfones.

### Materials of Devices Used in the Process

The polycarbonate solution comes into contact with the inner surfaces of various devices during the concentration steps. It was found that use of a nickel-based alloy comprising nickel and chromium for the inner surfaces of the devices used in step b) leads to less degradation of the polycarbonate.

Accordingly, in some preferred embodiments, at least a portion of the inner surface of at least one of the heat exchangers and/or at least a portion of the inner surface of at least one of the degassing vessels used in step b) is manufactured from a nickel-based alloy comprising nickel and chromium. Preferably, at least a portion of the inner surface of each of the heat exchangers and each of the degassing vessels used in step b) is manufactured from a nickel-based alloy comprising nickel and chromium.

An outlet of the heat exchanger may be an inlet of the degassing vessel. An outlet of the heat exchanger may also be connected e.g. by a connecting pipe to an inlet of the degassing vessel. In this case, it is preferred that at least portion of the inner surface of the connecting pipe connecting the outlet of the heat exchanger and the inlet of the degassing vessel is manufactured from a nickel-based alloy comprising nickel and chromium.

An outlet of the degassing vessel may be an inlet of the subsequent heat exchanger. An outlet of the degassing vessel may also be connected e.g. by a connecting pipe to an inlet of the subsequent heat exchanger. In this case, it is preferred that at least portion of the inner surface of the connecting pipe connecting the outlet of the heat exchanger and the inlet of the degassing vessel is manufactured from a nickel-based alloy comprising nickel and chromium.

It is preferred that any other surfaces that come into contact with the polycarbonate solution during step b) is at least partly manufactured from a nickel-based alloy comprising nickel and chromium.

Preferably, the nickel-based alloy comprises at least 40 wt % (e.g. 40 to 65 wt %) of nickel and at least 12 wt % (e.g. 12 to 25 wt %) of chromium. The nickel-based alloy optionally comprises molybdenum. The nickel-based alloy optionally comprises iron. The nickel-based alloy optionally comprises niobium and/or tantalum. Suitable examples include Inconel alloys such as Inconel 600, 617, 625, 690, nuclear grade 690, 718 and X-750 and Hastelloy alloys such as C-276 and C-22.

Preferably, the nickel-based alloy comprises at least 40 wt % of nickel (e.g. 40 to 65 wt %), at least 12 wt % (e.g. 12 to 25 wt %) of chromium and 1.0 to 20 wt % of molybdenum. Suitable examples include Inconel alloys such as Inconel 617, 625, and 718 and Hastelloy alloys such as C-276 and C-22.

Particularly preferably, the nickel-based alloy comprises the nickel-based alloy comprises at least 40 wt % of nickel (e.g. 40 to 65 wt %), at least 12 wt % (e.g. 12 to 25 wt %) of chromium and 5.0 to 12 wt % of molybdenum. Suitable examples include Inconel alloys such as Inconel 617 and 625.

Particularly preferably, the nickel-based alloy comprises the nickel-based alloy comprises at least 40 wt % of nickel (e.g. 40 to 65 wt %), at least 12 wt % (e.g. 12 to 25 wt %) of chromium and 5.0 to 12 wt % of molybdenum and further comprises niobium and/or tantalum wherein the total amount of niobium and/or tantalum is 1.0-5.0 wt %.

Suitable examples include Inconel 625. This leads to a significant less degradation of the polycarbonate.

In some preferred embodiments, the nickel-based alloy comprises at least 40 wt % of nickel (e.g. 40 to 65 wt %), at least 12 wt % (e.g. 12 to 25 wt %) of chromium and 12 to 20 wt % of molybdenum. Suitable examples include Hastelloy C-276 and C-22. Preferably, the nickel-based alloy comprises the nickel-based alloy at least 40 wt % of nickel (e.g. 40 to 65 wt %), at least 12 wt % (e.g. 12 to 25 wt %) of chromium 12 to 20 wt % of molybdenum and 12 to 17 wt % of chromium. Suitable examples include Hastelloy C-276.

Preferably, the nickel-based alloy is selected from the group consisting of Inconel 600, 617, 625, 690, nuclear grade 690, 718 and X-750 and Hastelloy C-276 and C-22, more preferably from the group consisting of Inconel 617, 625, and 718 and Hastelloy C-276 and C-22, more preferably from the group consisting of Inconel 617 and 625, most preferably the nickel-based alloy is Inconel 625.

Use of a nitriding steel for the inner surfaces of the devices used in step c) is preferred for causing less degradation of the polycarbonate.

Accordingly, it is preferred that at least a portion of the screw(s) and the inner surface of the barrel of the degassing extruder used in step c) is manufactured from a nitriding steel.

In the embodiments where a mechanical finisher is used in step c), it is preferred that at least a portion of the inner surface of the mechanical finisher is manufactured from a nitriding steel.

The invention is now elucidated by way of the following examples, without however being limited thereto.

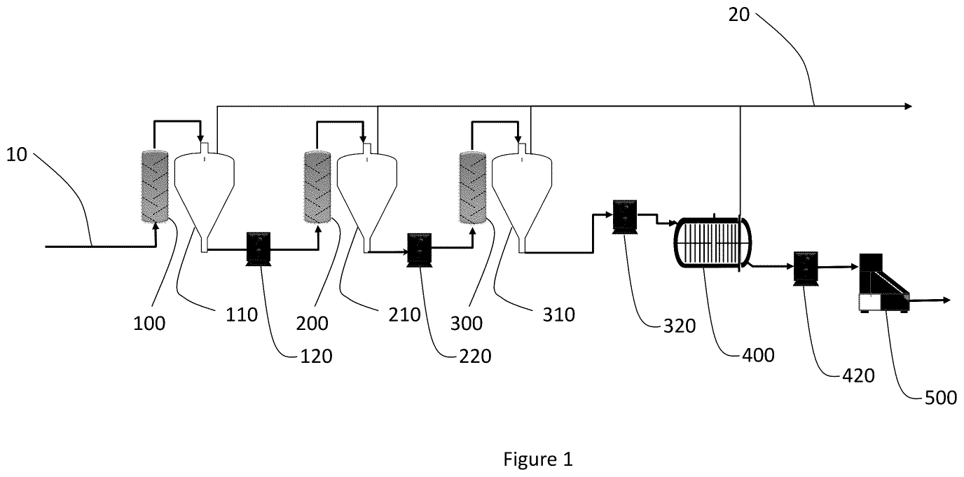

In FIG. 1, the system comprises a series of three devolatalization stages each comprising a heat exchanger and a degassing vessel. A solution of polycarbonate in an organic solvent comprising 5-40 wt. % of polycarbonate based on the weight of the solution is provided. The solution is supplied via line 10 to a first heat exchanger 100 and subsequently to a first degassing vessel 110 in which the solution is concentrated by removal of part of the organic solvent via line 20. A first pump 120 is used to supply the solution from the first degassing vessel 110 to a second heat exchanger 200 and subsequently to a second degassing vessel 210 in which the solution is further concentrated by removal of part of the organic solvent via line 20. A second pump 220 is used to supply the solution from the second degassing vessel 210 to a third heat exchanger 300 and subsequently to a third degassing vessel 310 in which the solution is further concentrated by removal of part of the organic solvent via line 20. A concentrated polycarbonate melt comprising the solvent is obtained in which the amount of the solvent is at most 5 wt. % and more than 500 ppm based on the weight of the concentrated polycarbonate melt.

A third pump 320 is used to supply the concentrated polycarbonate melt to a mechanical finisher 400 in which the concentration of the organic solvent is further reduced to at most 500 ppm.

A fourth pump 420 is used to supply the concentrated polycarbonate melt to a degassing extruder 500 in which the concentration of the organic solvent is further reduced. The degassing extruder is supplied with additives. Pellets of a polycarbonate composition comprising polycarbonate and additives are obtained, having a low level of organic solvent.

### Simulation

Tables 1-3 show the results of simulation of the polycarbonate concentrations of polycarbonate solutions subjected to a series of devolatalization stages under different temperatures and pressures (step b) of process of the invention).

The modeling was carried out utilizing Aspen Plus software, with the Poly-NRTL thermodynamic model being employed to calculate the phase behavior of the polymer and solvent system.

Viscosity modeling was carried out on the basis of experimental data wherein the viscosity of polycarbonate solutions in methylene chloride up to 80 wt. % was measured. Through interpolation and regression the appropriate viscosity models were included the Aspen Plus software.

The solubility phase diagram of the polycarbonate-methylene chloride system was integrated into the Aspen Plus simulations. In order to avoid issues related to solid precipitation out of the solvent it was found that a modified temperature, defined as the difference between the actual temperature and the boundary temperature between the two phases, was a crucial parameter. For a process to be feasible at any extraction stage, it is important that the modified temperature is at least 10° C. This minimum modified temperature ensures that there is no solid precipitation, allowing for integrity of the process.

The evaporation of solvent (here in Methylene Chloride) from the polymer solution, and the heat exchanger design, was simulated using the HTRI tool, specifically Xchanger Suite (version 9.1). CAPE-OPEN Protocol was used to link the HTRI unit operations to the ASPEN flowsheet. This linkage facilitated a seamless transfer of process conditions and enables the consistent execution of thermodynamic calculations based on the Poly-NRTL model between the HTRI software and Aspen Plus.

TABLE 1

| | Flash Stage 1 | | Flash Stage 2 | |
|---|---|---|---|---|
| | Heat | Flash | Heat | Flash |
| | Exchanger | Chamber | Exchanger | Chamber |
| PC Feed In | 18 | 54 | 73 | 84 |
| (wt %) | | | | |
| PC Feed | 54 | 73 | 84 | 99 |
| Out (wt %) | | | | |
| Temperature | 227 | 216 | 303 | 291 |
| (° C.) | | | | |
| Pressure | 35 | 25 | 26 | 1 |
| (BarA) | | | | |

TABLE 2

| | Flash Stage 1 | | Flash Stage 2 | |
|---|---|---|---|---|
| | Heat | Flash | Heat | Flash |
| | Exchanger | Chamber | Exchanger | Chamber |
| PC Feed In | 30 | 64 | 74 | 84 |
| (wt %) | | | | |
| PC Feed | 64 | 74 | 84 | 99 |
| Out (wt %) | | | | |
| Temperature | 218 | 218 | 282 | 282 |
| (° C.) | | | | |
| Pressure | 35 | 25 | 26 | 1 |
| (BarA) | | | | |

TABLE 3

| | Flash Stage 1 | | Flash Stage 2 | | Flash Stage3 | |
|---|---|---|---|---|---|---|
| | Heat | Flash | Heat | Flash | Heat | Flash |
| | Exchanger | Chamber | Exchanger | Chamber | Exchanger | Chamber |
| PC Feed In | 18 | 19 | 35 | 38 | 63 | 73 |
| (wt %) | | | | | | |
| PC Feed | 19 | 35 | 38 | 63 | 73 | 99 |
| Out (wt %) | | | | | | |
| Temperature | 185 | 104 | 229 | 196 | 294 | 272 |
| (° C.) | | | | | | |
| Pressure | 30 | 6 | 50 | 24 | 40 | 2 |
| (BarA) | | | | | | |

It can be understood that the polycarbonate concentration can be increased to 99 wt %, i.e. the organic solvent concentration can be decreased to 1 wt %.

Melts of polycarbonate having various levels of concentrations of methyl chloride were supplied to a degassing extruder under conditions shown in Table 4.

TABLE 4

| | Inlet | Temper- | | | | Outlet |
|---|---|---|---|---|---|---|
| | DCM | ature | Pressure | RPM | Rate | DCM |
| sample | (ppm) | (° C.) | (mbar) | (/min) | (Kg/hr) | (ppm) |
| 1 | 3,297 | 300 | 80 | 120 | 1.5 | Non- |
| | | | | | | Detect |
| 2 | 3,297 | 300 | 80 | 300 | 1.5 | Non- |
| | | | | | | Detect |
| 3 | 3,297 | 300 | 80 | 300 | 3.5 | 9 |
| 4 | 8,071 | 320 | 200 | 300 | 1.5 | 133 |
| 5 | 13,709 | 350 | 80 | 120 | 1.5 | 50 |
| 6 | 13,709 | 350 | 80 | 300 | 1.5 | Non- |
| | | | | | | Detect |
| 7 | 13,709 | 350 | 80 | 450 | 1.5 | Non- |
| | | | | | | Detect |

It can be understood that desired low levels of organic solvent can be obtained by selecting conditions under which a degassing extruder is operated.

1. A process for producing polycarbonate comprising the steps of
a) providing a solution of polycarbonate in an organic solvent wherein the solution comprises 5-40 wt. % of polycarbonate, based on the weight of the solution,
b) concentrating and heating the solution of step a) to form a concentrated polycarbonate melt comprising the solvent wherein the concentrated polycarbonate melt comprises at most 5 wt. % and more than 500 ppm of solvent, based on the weight of the concentrated polycarbonate melt and
c) further concentrating the concentrated polycarbonate of step b) to a polycarbonate comprising at most 500 ppm of organic solvent,
wherein step b) is carried out by subjecting the solution to at least two devolatalization stages in series, wherein each devolatalization stage comprises heating the solution by means of a heat exchanger and subsequently feeding the heated solution to a degassing vessel, wherein at least part of the solvent is separated from the solution by evaporation, and
step c) is carried out at least in a degassing extruder.

2. The process of claim 1, wherein the amount of organic solvent in the polycarbonate obtained from step c) is at most 100 ppm.

3. The process of claim 1, wherein the organic solvent comprises from 70 wt. % to 90 wt. % of methylene chloride.

4. The process of claim 1, wherein the organic solvent is methylene chloride, chlorobenzene or a mixture of chlorobenzene and methylene chloride.

5. The process of claim 1, wherein the polycarbonate solution comprises 15-30 wt. % of polycarbonate.

6. The process of claim 1, wherein in step c) prior to the feeding the concentrated polycarbonate to said degassing extruder the concentrated polycarbonate is further concentrated in one or more mechanical finishers, wherein inside the mechanical finisher(s) the concentrated polycarbonate melt is maintained in molten state under vacuum conditions at a pressure of at most 50 kPa (500 mbar) and wherein said mechanical finishers continuously or intermittently allows for the renewal of the surface area of the polycarbonate melt that is exposed to the vacuum.

7. The process of claim 6, wherein the temperature inside the mechanical finisher is from 250° C. to 350° C. and/or the pressure is from 0.1 to 50 kPa.

8. The process of claim 6, wherein the mechanical finisher is selected from at least one of a disc-ring reactor, a disc-cage reactor, a thin film evaporator or wiped film evaporator, a falling film evaporator, a horizontal twin-shaft polymerizer, twin-screw kneader and wire-wetting fall polymerizer.

9. The process of claim 6, wherein the volume occupied by the polycarbonate melt in the mechanical finisher is at most 60% of the internal volume of the mechanical finisher.

10. The process of claim 6, wherein the residence time in the mechanical finisher is at least 5 minutes.

11. The process of claim 6, wherein the mechanical finisher comprises a mixing device that continuously mixes the polycarbonate melt thereby continuously renewing the surface area of the polycarbonate melt that is exposed to the vacuum.

12. The process of claim 1, wherein an inert gas other than the solvent is added to the degassing extruder and/or to the mechanical finisher.

13. The process of claim 1, wherein at least one of the heat exchangers is supplied with the solution at a top part of the heat exchanger and the solution is heated in the heat exchanger by flowing downwardly from the top part to a bottom part of the heat exchanger.

14. The process of claim 1, wherein at least a portion of the inner surface of at least one of the heat exchangers and/or at least a portion of the inner surface of at least one of the degassing vessels used in step b) is manufactured from a nickel-based alloy comprising nickel and chromium.
